(19) United States
(12) Patent Application Publication
(10) Pub. No.: US 2023/0422214 A1
(43) Pub. Date: Dec. 28, 2023

(54) METHODS FOR INFORMATION CONFIGURATION IN WIRELESS COMMUNICATION

(71) Applicant: ZTE Corporation, Shenzhen (CN)

(72) Inventors: Jie TAN, Shenzhen (CN); Xiubin SHA, Shenzhen (CN); Bo DAI, Shenzhen (CN); Ting LU, Shenzhen (CN)

(21) Appl. No.: 18/466,671

(22) Filed: Sep. 13, 2023

Related U.S. Application Data
(63) Continuation of application No. PCT/CN2021/083324, filed on Mar. 26, 2021.

(51) Int. Cl. H04W 68/02; H04W 76/28

(52) U.S. Cl. CPC H04W 68/02; H04W 76/28

(57) ABSTRACT

Systems, apparatus, and methods for wireless communication are described, and more specifically, to techniques related to discontinuous reception (DRX), Daylight Saving Time (DST), and leap seconds. One example method for wireless communication includes determining a target paging cycle associated with a wireless device based on whether an extended DRX value is configured. Another example method for wireless communication includes receiving, from a network device at a first time prior to a second time, an interface message including time information and adjusting, at a second time, a local time based on the time information.

### CROSS-REFERENCE TO RELATED APPLICATION

This application is a continuation and claims priority to International Application No. PCT/CN2021/083324, filed on Mar. 26, 2021, the disclosure of which is hereby incorporated by reference herein in its entirety.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for transmitting configuration information in mobile communication technology, including 5th Generation (5G), and new radio (NR) communication systems.

In one exemplary aspect, a wireless communication method is disclosed. The method includes determining a target paging cycle associated with a wireless device based on whether an extended discontinuous reception (DRX) value is configured.

In another exemplary aspect, a wireless communication method is disclosed. The method includes transmitting, to a wireless device at a first time prior to a second time, an interface message including time information. The method also includes causing, at the first time, the second time, and a third time, the wireless device to adjust a local time based on the time information.

In another exemplary aspect, a wireless communication method is disclosed. The method includes receiving, from a network device at a first time prior to a second time, an interface message including time information. The method also includes adjusting, at the first time, the second time and a third time, a local time based on the time information.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of a base station (BS) and user equipment (UE) in wireless communication.

FIG. 2 shows an example method to determine a target paging cycle.

FIG. 3 shows a switch from DST to Standard time.

FIG. 4 shows a switch from Standard time to DST.

FIG. 5 shows a clock where a leap second is added, and the last minute of a day has 61 seconds.

FIG. 6 shows a clock where a leap second is subtracted, and the last minute of a day has 59 seconds.

FIG. 7 shows an example method to adjust a local clock.

FIG. 8 is a block diagram representation of a portion of an apparatus that can be used to implement methods and/or techniques of the presently disclosed technology.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems

According to current wireless communication standards, user equipment (UE) may use Discontinuous Reception (DRX) in idle mode in order to reduce power consumption. DRX of a UE in idle mode is mainly used to monitor the paging channel and broadcast channel. This purpose can be achieved as long as a fixed DRX cycle is defined.

The current method of determining the DRX cycle is described as follows. If a UE specific extended DRX value of 512 radio frames is configured by the upper layers, then the DRX cycle of the UE is T=512. Otherwise, the DRX cycle of the UE is determined by the shortest of: the UE specific DRX value, if allocated by the upper layers, and a default DRX value broadcast in system information. If the UE specific DRX value is not configured by the upper layers, then the default DRX value is applied.

For a UE in the RRC_INACTIVE state, if the extended DRX value is not configured by the upper layers, then the DRX cycle of the UE is determined by the shortest of: the radio access network (RAN) paging cycle, the UE specific paging cycle, and the default paging cycle, if allocated by upper layers. Otherwise, if the UE is in the RRC_INACTIVE state and the extended DRX value is configured by upper layers, then the DRX cycle of the UE is determined by the shortest of: the RAN paging cycle, the UE specific paging cycle, if allocated by upper layers, and the default paging cycle during the paging time window (PTW). The target paging cycle is set as the RAN paging cycle outside the PTW.

Since the PTW is an optional information element (IE) in the current standard, further analysis is needed of methods to determine the DRX cycle of a UE when PTW is not configured.

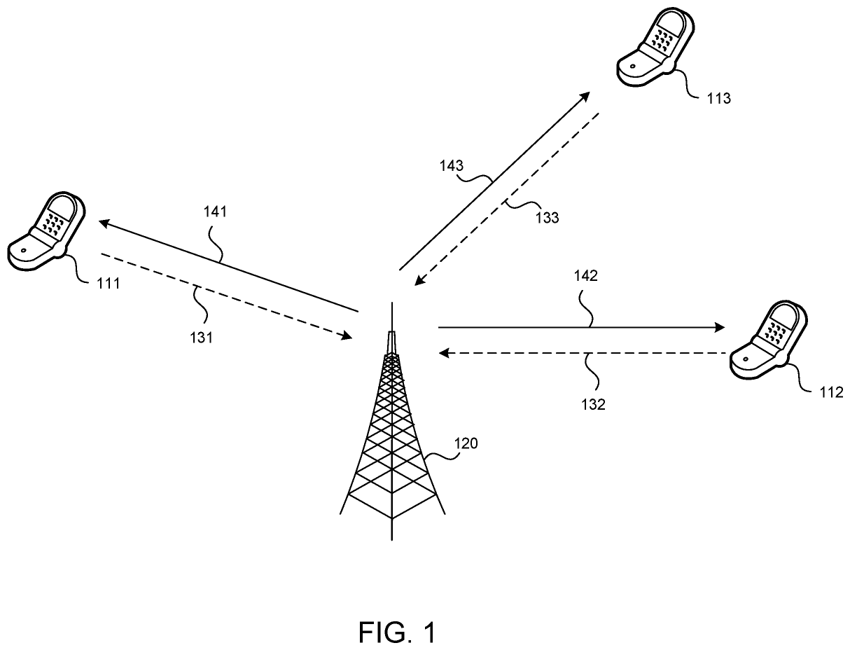

FIG. 1 shows an example of a wireless communication system (e.g., a long term evolution (LTE), 5G or NR cellular network) that includes a base station (BS) 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

### Example 1

In some embodiments, the target paging cycle in the RRC_INACTIVE state or idle mode is determined by whether the extended DRX value is configured by the upper layer.

When the extended DRX is not configured by the upper layer, the target paging cycle in the RRC_INACTIVE state can be determined based on whether the UE specific paging cycle is configured or not, including at least one of the following:
When a UE specific paging cycle is configured, the target paging cycle can be determined by the shortest of the RAN paging cycle, the UE specific paging cycle, and the default paging cycle.
When the UE specific paging cycle is not configured, the target paging cycle can be determined by the shortest of the RAN paging cycle, and the default paging cycle.

When the extended DRX is configured by the upper layer, the target paging cycle of a UE in the RRC_INACTIVE state or idle mode can be determined based on the UE specific extended DRX value, including at least one of the following:
For enhanced Machine Type Communication (eMTC): When the UE specific extended DRX value is configured as 512 radio frames, the target paging cycle of the UE can be determined in the RRC_INACTIVE state as the shortest of the RAN paging cycle and the cycle of 512 wireless frame without using the PTW.
For new radio (NR): When the UE specific extended DRX value is configured as 1024 radio frames, the target paging cycle of a UE configured in idle mode with 1024 wireless frames as the cycle can be determined without using the PTW.
For NR: When the UE specific extended DRX value is configured as 1024 radio frames, the target paging cycle of a UE in the RRC_INACTIVE state can be determined as the RAN paging cycle without using the PTW.

The RAN paging cycle configured in the RRC_INACTIVE state as a RRC_INACTIVE configuration parameter can be configured via UE specific signaling. The UE specific extended DRX value can be the paging cycle parameter that the upper layer configures to the UE. The default paging cycle can be broadcast to the UE by gNodeB (gNB). The UE specific paging cycle can be sent to the UE by the core network after negotiation between the UE and the core network through non-access stratum (NAS).

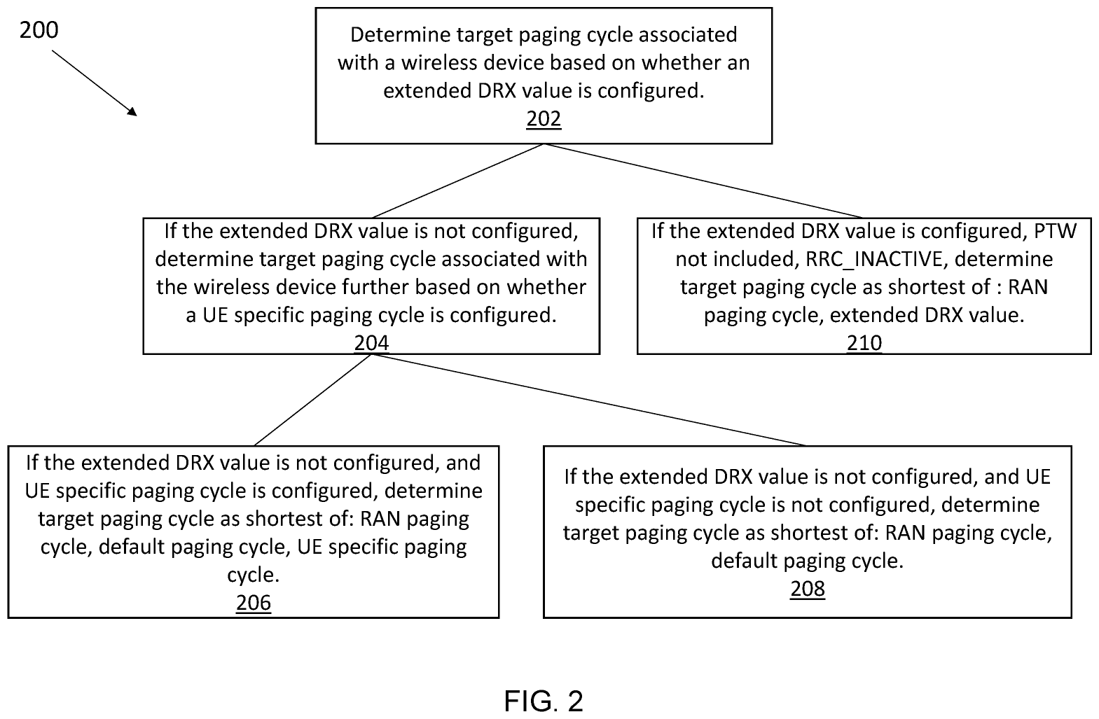

FIG. 2 shows an example method 200 to determine a target paging cycle. At 202, a target paging cycle associated with a wireless device is determined based on whether an extended DRX value is configured. At 204, if the extended DRX value is not configured, the target paging cycle associated with the wireless device is determined further based on whether a UE specific paging cycle is configured. Although 202 and 204 are shown separately for illustrative purposes, the method can be performed separately or in a single step by determining the target paging cycle based on the extended DRX value and the UE specific paging cycle simultaneously.

At 206, if the extended DRX value is not configured, and the UE specific paging cycle is configured, then the target paging cycle can be the shortest of: a radio access network (RAN) paging cycle, a default paging cycle, and the UE specific paging cycle. At 208, if the extended DRX value is not configured and the UE specific paging cycle is not configured, then the target paging cycle can be the shortest of: a RAN paging cycle and a default paging cycle. At 210, if the extended DRX value is configured, a paging time window (PTW) is not included, and the wireless device is in an RRC_INACTIVE state, then the target paging cycle can be the shortest of: a RAN paging cycle and the extended DRX value.

### Example 2

Daylight-saving time (DST) is implemented in some countries for power saving, which impacts a UE's local time clock. The switch between DST and Standard time is determined by each country's government and usually shifts clocks by one hour. If a switch between DST and Standard time occurs, there can be a time difference of 1 hour between a UE and a gNB when the UE's clock is synchronized with the gNB's clock by receiving reference time information through the UMTS air interface (Uu interface). This time difference lasts for the duration between the time the DST/Standard switch occurs and the subsequent reception of reference time information.

### Case 1

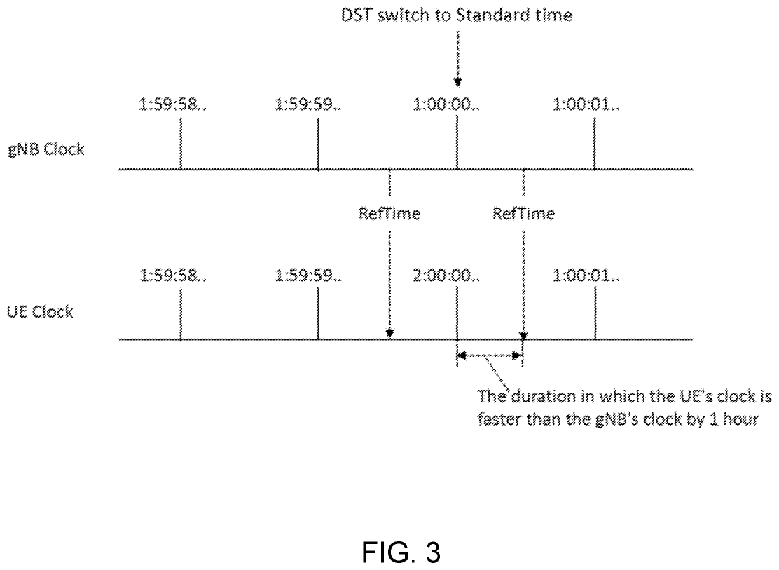

FIG. 3 shows a switch from DST to Standard time. As shown, the switch from DST Standard time occurs at 2:00:00. In between the 2:00:00 DST/Standard switch time and the subsequent reception of reference time information, the UE's clock is faster than the gNB's clock by 1 hour, which can lead to a deterministic Quality of Service (QoS) error of 1 hour (e.g., a 1 hour increase in uplink delay and a 1 hour decrease in downlink delay).

In order to avoid such errors, the UE can receive an interface message sent by the gNB, wherein the interface message contains at least one of the following: a DLInformationTransfer message and system information block 9 (SIB9). The DLInformationTransfer message can contain the following optional information elements: dayLightSavingTime, leapSeconds, leapSecondIndicator, and dayLightSavingTimeIndicator. SIB9 can contain the following optional parameters: leapSecondIndicator and dayLightSavingTimeIndicator. dayLightSavingTime can indicate if and how DST is applied to obtain the local time. leapSeconds can be a number of leap seconds offset between Global Positioning System (GPS) Time and Coordinated Universal Time (UTC). leapSecondIndicator can indicate whether there is leap second in the last minute of the day. dayLightSavingTimeIndicator can indicate if and how DST is applied in the next hour. Synchronization time information, prediction information indicating a switch from DST to Standard time, and prediction information indicating whether there is a leap second in the last minute of the day are parsed from the interface message. The UE clock can synchronize with the gNB clock according to the received synchronization time information and prediction information.

The prediction information indicating a switch from DST to Standard time can include at least one of the following: information indicating a switch from DST to Standard time, and a 2 bit indication message containing information on how to apply DST to obtain a local clock. The 2 bit indication message can indicate how to apply DST, for example, as follows: if a parameter DayLightSavingTime is set to “01”, this can correspond to a −1 hour adjustment from DST. Between the time that DST changes to Standard time (e.g., 2:00:00) and the time the UE receives subsequent reference time information, the UE clock can calculate minus 3600 seconds and add a leap second value (if any). If DayLightSavingTime is set to “10”, this can correspond to a −2 hour adjustment from DST. Between the time that DST changes to Standard time (e.g., 2:00:00) and the time the UE receives subsequent reference time information, the UE clock can calculate minus 7200 seconds and add a leap second value (if any).

### Case 2

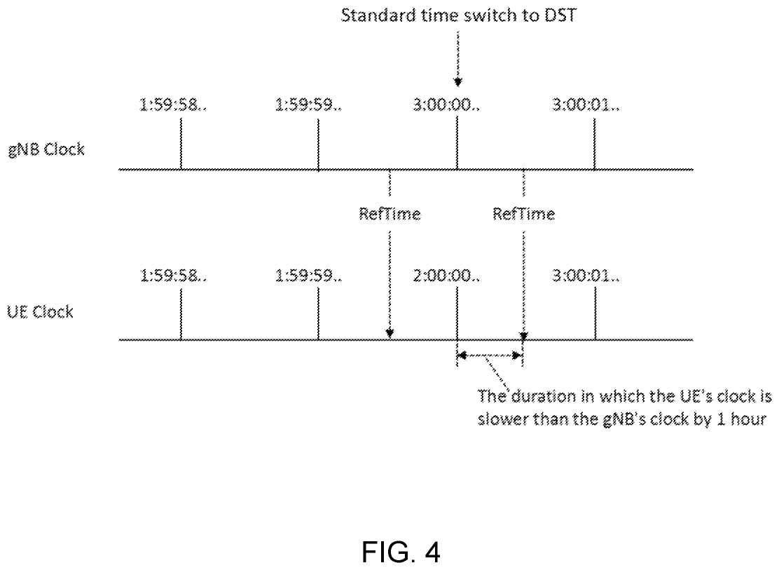

FIG. 4 shows a switch from Standard time to DST. As shown, the switch from Standard time to DST occurs at 2:00:00. In between the Standard time/DST switch time and the subsequent reception of reference time information, the UE's clock is slower than the gNB's clock by 1 hour, which can lead to a deterministic QoS error of 1 hour (e.g., uplink delay decreases 1 hour and downlink delay increases 1 hour).

In order to avoid such errors, the UE can receive an interface message sent by the gNB, wherein the interface message contains at least one of the following: a DLInformationTransfer message and SIB9. The DLInformationTransfer message can contain the following optional information elements: dayLightSavingTime, leapSeconds, leapSecondIndicator, and dayLightSavingTimeIndicator. SIB9 can contain the following optional parameters: leapSecondIndicator and dayLightSavingTimeIndicator. dayLightSavingTime can indicate if and how DST is applied to obtain the local time. leapSeconds can be the number of leap seconds offset between GPS Time and UTC. leapSecondIndicator can indicate whether there is leap second in the last minute of the day. dayLightSavingTimeIndicator can indicate if and how DST is applied in the next hour. Synchronization time information, prediction information indicating a switch from Standard time to DST, and prediction information indicating whether there is a leap second in the last minute of the day are parsed from the interface message. The UE clock can synchronize with the gNB clock according to the received synchronization time information and prediction information.

The prediction information indicating a switch from Standard time to DST can include at least one of the following: information indicating a switch from Standard time to DST, and a 2 bit indication message containing information on how to apply Standard time to obtain a local clock. The 2 bit indication message can indicate how to apply Standard time, for example, as follows: if a parameter DayLightSavingTime is set to “01”, this can correspond to a +1 hour adjustment from Standard time. Between the time that Standard time changes to DST (e.g., 2:00:00) and the time the UE receives subsequent reference time information, the UE clock can calculate plus 3600 seconds and add a leap second value (if any). If DayLightSavingTime is set to “10”, this can correspond to a +2 hour adjustment from Standard time. Between the time that Standard time changes to DST (e.g., 2:00:00) and the time the UE receives subsequent reference time information, the UE clock can calculate plus 7200 seconds and add a leap second value (if any).

The leap second value can indicate a leap second offset between GPS time and UTC. That is, GPS Time−leapSecond=UTC time. Prediction information corresponding to whether there is a leap second at the last minute of the day can include at least one of the following: a value noWarning corresponding to no leap second in the last minute of the day; a value sec61 corresponding to the last minute of the day having 61 seconds; and a value sec59 corresponding to the last minute of the day having 59 seconds.

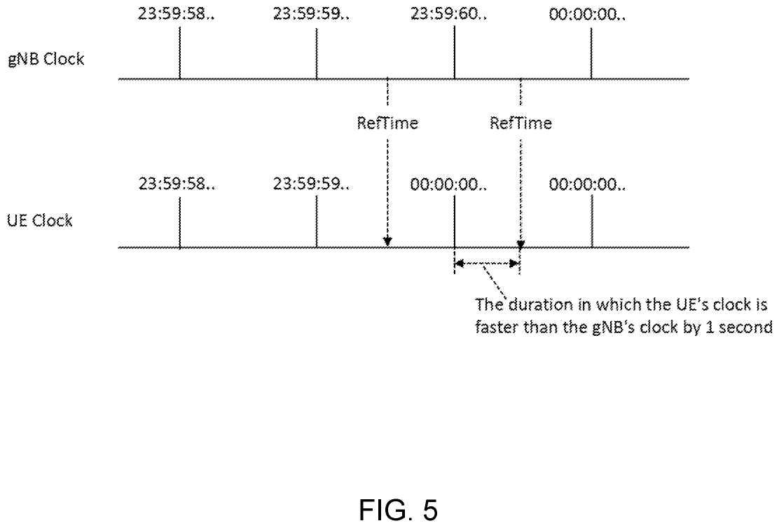

FIG. 5 shows a clock where a leap second is added, and the last minute of a day has 61 seconds. If prediction information corresponding to a leap second is set to sec61, then the UE can set leapSeconds=leapSeconds+1 in the time between when the leap second occurs and the subsequent reception of reference time information. In the time between the occurrence of the leap second (e.g. 23:59:60) and the subsequent reception of reference time information, the UE's clock is faster than the gNB's clock by 1 second, which can lead to a deterministic QoS error of 1 second (e.g., uplink delay increases by 1 second and downlink delay decreases by 1 second).

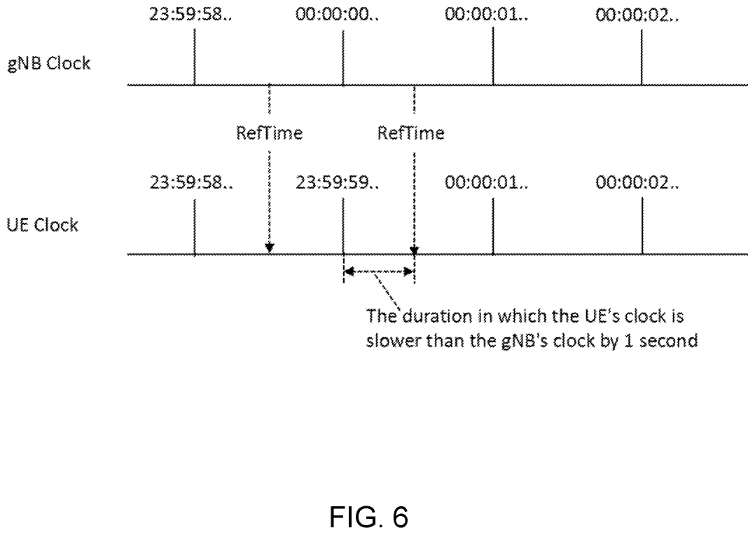

FIG. 6 shows a clock where a leap second is subtracted, and the last minute of a day has 59 seconds. If prediction information corresponding to a leap second is set to sec59, then the UE can set leapSeconds=leapSeconds−1 in the time between when the leap second occurs and the subsequent reception of reference time information. In the time between the occurrence of the leap second (e.g., 00:00:00) and the subsequent reception of reference time information, the UE's clock is slower than the gNB's clock by 1 second, which can lead to a deterministic QoS error of 1 second (e.g., uplink delay decreases by 1 second and downlink delay increases by 1 second).

Through the above methods, a prediction of a DST/Standard time clock switch and a prediction of a leap second can be obtained in advance. Based on synchronization time information, prediction information of a clock switch, and prediction information of a leap second, a UE can keep time synchronization with a gNB when a DST/Standard time switch occurs, in addition to an occurrence of a leap second. This improves the accuracy of time synchronization. Furthermore, the analysis described above for Case 1 and Case 2 can be combined. For example, a formula for calculating the reference time with granularity 10 ns on the UE side is: time=refDays*86400*1000*100000+refSeconds*1000*100000+refMilliSeconds*100000+refTenNanoSeconds+leapSeconds*1000*100000+dayLightSavingTimeOffset. The value of the leapSeconds can be calculated using a leapSeconds parameter transmitted by the base station and included in the prediction information corresponding to a leap second. For example, the value of leapSeconds can be a leapSeconds parameter sent by the base station.

In some embodiments, a formula for calculating the reference time with granularity 10 ns on the UE side is: time=time+leapSecondsoffset*1000*100000, wherein the value of leapSecondsoffset is +1 second or −1 second, depending on the prediction information corresponding to a leap second. For example, if the prediction information indicates that there are 59 seconds in the last minute of a day, then leapSecondsoffset can be −1 second, and if the prediction information indicates that there are 61 seconds in the last minute of a day, then leapSecondsoffset can be +1 second. In some embodiments, a formula for calculating the reference time with granularity 10 ns on the UE side is: time=time+dayLightSavingTimeOffset, wherein the values of dayLightSavingTimeOffset is calculated using a dayLightSavingTimeOffset parameter transmitted by the base station and included in prediction information corresponding to DST.

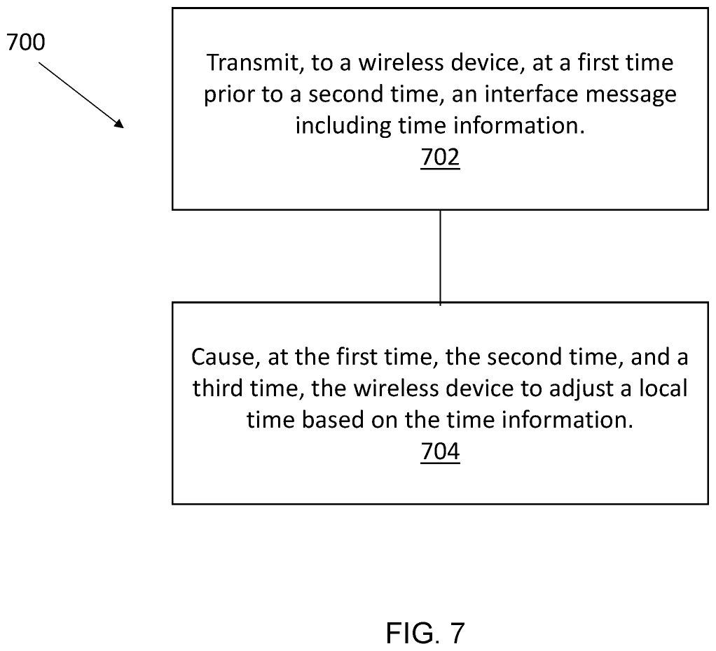

FIG. 7 shows an example method 700 to adjust a local clock. At 702, at a first time prior to a second time, an interface message including time information is transmitted to a wireless device. For example, the time information can be transmitted from a BS. The time information can include information indicating a transition between DST and Standard time. The time information can include information indicating the occurrence of a leap second. At 704, at the second time, the wireless device can be caused to adjust a local time (i.e., local clock) based on the time information. The second time can be the time that a transition between DST and standard time occurs. The second time can be the time that a leap second occurs. The method can further include transmitting time information to the wireless device at a third time following the second time.

In some embodiments, the time information can include a value daylightSavingTimeOffset. The wireless device can adjust the local time based on the value daylightSavingtTimeOffset, for example, by adding daylightSavingTimeOffset. In one example, for a local time with granularity of 10 ns, the value of daylightSavingTimeOffset can be 3600*1000*100000 to correspond to leaping forward one hour, 7200*1000*100000 to correspond to leaping forward two hours, −3600*1000*100000 to correspond to falling back one hour, or −7200*1000*100000 to correspond to falling back two hours. Other values or calculations can be used to correspond to different time adjustments or different clock granularities.

In some embodiments, the time information can include a value leapSecondsoffset. The wireless device can adjust the local time based on the value leapSecondsoffset, for example, by adding leapSecondsoffset*1000*100000, such as for a local time with granularity of 10 ns. In one example, the value of leapSecondsoffset is set to +1 to correspond to the addition of a leap second, i.e., a last minute of a day having 61 seconds. In one example, the value of leapSecondsoffset is set to −1 to correspond to the subtraction of a leap second, i.e., a last minute of a day having 59 seconds. Other values or calculations can be used to correspond to different leap second adjustments or different clock granularities. In some embodiments, the time information can include any of the information and indicators described herein, such as described for FIGS. 3-6.

Some embodiments may preferably incorporate the following solutions as described herein.

For example, the solutions listed below may be used by a network device or a wireless device for determining a target paging cycle as described herein. (e.g., as described for Example 1.)

1. A method (e.g., method 200 described in FIG. 2) of wireless communication comprising: determining a target paging cycle associated with a wireless device based on whether an extended discontinuous reception (DRX) value is configured (202).

2. The method of solution 1, wherein the extended DRX value is not configured, and wherein the determining the target paging cycle is further based on whether a UE specific paging cycle is configured (204).

3. The method of solution 2, wherein the UE specific paging cycle is configured, and the target paging cycle is the shortest of: a radio access network (RAN) paging cycle, a default paging cycle, and the UE specific paging cycle (206).

4. The method of solution 2, wherein the UE specific paging cycle is not configured, and the target paging cycle is the shortest of: a RAN paging cycle and a default paging cycle (208).

5. The method of solution 1, wherein the extended DRX value is configured and a paging time window (PTW) is not included, the wireless device is in an RRC_INACTIVE state, and the target paging cycle is the shortest of: a RAN paging cycle and the extended DRX value (210).

For example, the solutions listed below may be used by a network device for implementing a transition between DST and Standard time or leap second as described herein (e.g., as described in Example 2.)

6. A method (e.g., method 700 described in FIG. 7) of wireless communication comprising: transmitting, to a wireless device at a first time prior to a second time, an interface message including time information (702); and causing, at the first time, the second time, and a third time, the wireless device to adjust a local time based on the time information (704).

7. The method of solution 6, wherein: the time information includes an indication of a transition between Daylight Saving Time (DST) and standard time; and the transition between DST and standard time occurs at the second time (e.g., as described in Case 1 and FIGS. 3 and 4).

8. The method of solution 7, wherein the interface message includes a DST value indicating whether to adjust the local time by one or two hours.

9. The method of solution 6, wherein: the time information includes an indication of an occurrence of a leap second; the wireless device adjusts the local time by subtracting one second, or adding one second, based on the prediction information; and the leap second occurs at the second time (e.g., as described in Case 2 and FIGS. 5 and 6).

10. The method of solution 9, wherein the time information indicates one of the following: a last minute of a day has 61 seconds, the last minute of the day has 59 seconds, and the last minute of the day has no leap seconds.

11. The method of solution 6, wherein: the local time has a granularity of 10 nanoseconds; the time information includes a leapSeconds value; and the wireless device adjusts the local time based on the equation: time=refDays*86400*1000*100000+refSeconds*1000*100000+refMilliSeconds*100000+refTenNanoSeconds+leapSeconds*1000*100000.

12. The method of solution 11, wherein: refDays is a first parameter included in the time information indicative of a number of days from a time origin; refSeconds is a second parameter included in the time information indicative of a number of seconds that have passed in a current day; refMilliseconds is a third parameter included in the time information indicative of a number of milliseconds that have passed in a current second; refTenNanoseconds is a fourth parameter included in the time information indicative of a number of time units that have passed in a current millisecond, wherein the time unit is ten nanoseconds.

13. The method of solution 11, wherein: the leapSeconds value indicates a number of leap seconds offset between GPS time and UTC time; and reference time information including leapSeconds is transmitted to the wireless device at the third time.

14. The method of solution 6, wherein: the local time has a granularity of 10 nanoseconds; the time information includes a leapSecondsoffset value and an indication corresponding to a leap second; and the wireless device adjusts the local time based on the indication corresponding to the leap second and by adding leapSecondsoffset*1000*100000 (e.g., as described in Case 2).

15. The method of solution 14, wherein: the indication corresponding to the leap second is set to 61 seconds at the first time; the wireless device adjusts the local time by setting leapSecondsoffset to +1; and the leap second occurs at the second time.

16. The method of solution 14, wherein: the indication corresponding to the leap second is set to 59 seconds at the first time; the wireless device adjusts the local time by setting leapSecondsoffset to −1; and the leap second occurs at the second time.

17. The method of solution 6, wherein: the local time has a granularity of 10 nanoseconds, the time information includes dayLightSavingTimeOffset and an indication corresponding to a transition between DST and standard time, and the wireless device adjusts the local time based on the indication and by adding dayLightSavingTimeOffset (e.g., as described in Case 2).

18. The method of solution 17, further comprising: causing the wireless device to set a default DayLightSavingTimeOffset to 0 at the first time and a third time.

19. The method of solution 17, wherein: the transition between DST and standard time is from standard time to DST with a 1 hour adjustment; the wireless device adjusts the local time by setting dayLightSavingTimeOffset to 3600*1000*100000; and the transition between DST and standard time occurs at the second time.

20. The method of solution 17, wherein: the transition between DST and standard time is from standard time to DST with a 2 hour adjustment; the wireless device adjusts the local time by setting dayLightSavingTimeOffset to 7200*1000*100000; and the transition between DST and standard time occurs at the second time.

21. The method of solution 17, wherein: the transition between DST and standard time is from DST to standard time with a 1 hour adjustment; the wireless device adjusts the local time by setting dayLightSavingTimeOffset to −3600*1000*100000; and the transition between DST and standard time occurs at the second time.

22. The method of solution 17, wherein: the transition between DST and standard time is from DST to standard time with a 2 hour adjustment; the wireless device adjusts the local time by setting dayLightSavingTimeOffset to −7200*1000*100000; and the transition between DST and standard time occurs at the second time.

23. The method of solution 6, wherein the interface message includes at least one of: a DLInformationTransfer message or a system information block (SIB) 9.

For example, the solutions listed below may be used by a wireless device for implementing a transition between DST and Standard time or leap second as described herein (e.g., as described in Example 2.)

24. A method (e.g., method 700 described in FIG. 7) of wireless communication comprising: receiving, from a network device at a first time prior to a second time, an interface message including time information (702); and adjusting, at the first time, the second time and a third time, a local time based on the time information (704).

25. The method of solution 24, wherein: the time information includes an indication of a transition between Daylight Saving Time (DST) and standard time; and the transition between DST and standard time occurs at the second time (e.g., as described in Case 1 and FIGS. 3 and 4).

26. The method of solution 25, wherein the interface message includes a DST value indicating whether to adjust the local time by one or two hours.

27. The method of solution 24, wherein: the time information includes an indication of an occurrence of a leap second; the adjusting the local time comprises subtracting one second, or adding one second based on the prediction information; and the leap second occurs at the second time (e.g., as described in Case 2 and FIGS. 5 and 6).

28. The method of solution 27, wherein the prediction information indicates one of the following: a last minute of a day has 61 seconds, and the last minute of the day has 59 seconds.

29. The method of solution 24, wherein: the local time has a granularity of 10 nanoseconds; the time information includes a leapSeconds value; and the adjusting the local time is based on the leap second indication and the equation: time=refDays*86400*1000*100000+refSeconds*1000*100000+refMilliSeconds*100000+refTenNanoSeconds+leapSeconds*1000*100000 (e.g., as described in Case 2).

30. The method of solution 29, wherein: refDays is a first parameter included in the time information indicative of a number of days from a time origin; refSeconds is a second parameter included in the time information indicative of a number of seconds that have passed in a current day; refMilliseconds is a third parameter included in the time information indicative of a number of milliseconds that have passed in a current second; refTenNanoseconds is a fourth parameter included in the time information indicative of a number of time units that have passed in a current millisecond, wherein the time unit is ten nanoseconds.

31. The method of solution 29, wherein: the leapSeconds value indicates a number of leap seconds offset between GPS time and UTC time; and reference time information including leapSeconds is received at third time.

32. The method of solution 24, wherein: the local time has a granularity of 10 nanoseconds; the time information includes a leapSeconds value and an indication corresponding to a leap second; and the adjusting the local time is based on the leap second indication and by adding leapSecondsoffset*1000*100000 (e.g., as described in Case 2).

33. The method of solution 32, wherein: the indication corresponding to the leap second is set to 61 seconds; the adjusting the local time comprises setting leapSecondsoffset to +1; and the leap second occurs at the second time.

34. The method of solution 32, wherein: the indication corresponding to the leap second is set to 59 seconds; the adjusting the local time comprises setting leapSecondsoffset to −1; and the leap second occurs at the second time.

35. The method of solution 24, wherein: the local time has a granularity of 10 nanoseconds, the time information includes dayLightSavingTimeOffset and an indication corresponding to a transition between DST and standard time, and the adjusting the local time is based on the indication and by adding dayLightSavingTimeOffset (e.g., as described in Case 2).

36. The method of solution 35, further comprising: setting a default DayLightSavingTimeOffset to 0 at the first time and a third time.

37. The method of solution 35, wherein: the transition between DST and standard time is from standard time to DST with a 1 hour adjustment; the adjusting the local time comprises setting dayLightSavingTimeOffset to 3600*1000*100000; and the transition between DST and standard time occurs at the second time.

38. The method of solution 35, wherein: the transition between DST and standard time is from standard time to DST with a 2 hour adjustment; the adjusting the local time comprises setting dayLightSavingTimeOffset to 7200*1000*100000; and the transition between DST and standard time occurs at the second time.

39. The method of solution 35, wherein: the transition between DST and standard time is from DST to standard time with a 1 hour adjustment; the adjusting the local time comprises setting dayLightSavingTimeOffset to −3600*1000*100000; and the transition between DST and standard time occurs at the second time.

40. The method of solution 35, wherein: the transition between DST and standard time is from DST to standard time with a 2 hour adjustment; the adjusting the local time comprises setting dayLightSavingTimeOffset to −7200*1000*100000; and the transition between DST and standard time occurs at the second time.

41. The method of solution 24, wherein the interface message includes at least one of: a DLInformationTransfer message or a system information block (SIB) 9.

For example, the solutions listed below may an apparatus or computer readable medium for implementing UE configuration as described herein.

A wireless apparatus comprising a processor configured to implement the method of any of solutions 1 to 41.

A computer readable medium having code stored thereon, the code when executed by a processor, causing the processor to implement a method recited in any of solutions 1 to 41.

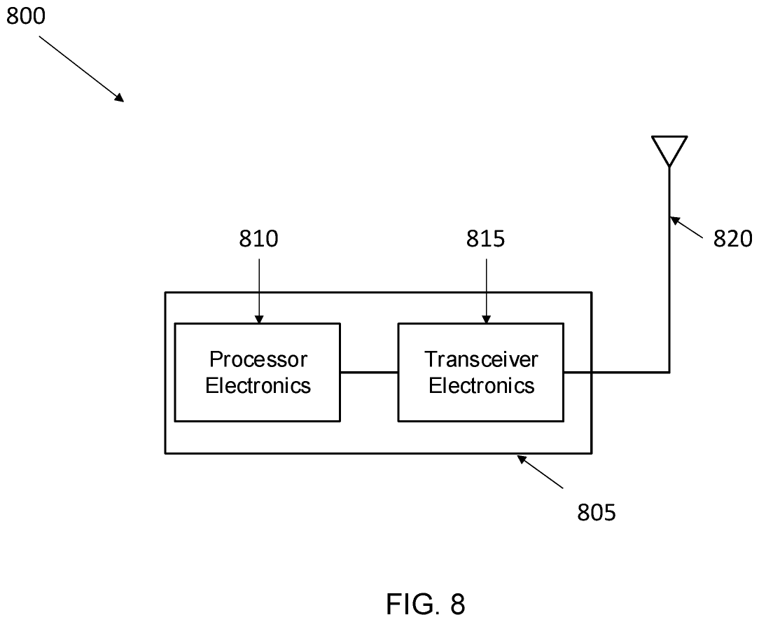

FIG. 8 is a block diagram representation of a portion of an apparatus, in accordance with some embodiments of the presently disclosed technology. An apparatus 805 such as a network device or a base station or a wireless device (or UE), can include processor electronics 810 such as a microprocessor that implements one or more of the techniques presented in this document. The apparatus 805 can include transceiver electronics 815 to send and/or receive wireless signals over one or more communication interfaces such as antenna(s) 820. The apparatus 805 can include other communication interfaces for transmitting and receiving data. Apparatus 805 can include one or more memories (not explicitly shown) configured to store information such as data and/or instructions. In some implementations, the processor electronics 810 can include at least a portion of the transceiver electronics 815. In some embodiments, at least some of the disclosed techniques, modules or functions are implemented using the apparatus 805.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure.

1. A method of wireless communication comprising:
determining a target paging cycle associated with a wireless device based on whether an extended discontinuous reception (DRX) value is configured.

2. The method of claim 1, wherein the extended DRX value is not configured, and wherein the determining the target paging cycle is further based on whether a UE specific paging cycle is configured.

3. The method of claim 2, wherein the UE specific paging cycle is configured, and the target paging cycle is a shortest of: a radio access network (RAN) paging cycle, a default paging cycle, and the UE specific paging cycle.

4. The method of claim 2, wherein the UE specific paging cycle is not configured, and the target paging cycle is a shortest of: a RAN paging cycle and a default paging cycle.

5. The method of claim 1, wherein the extended DRX value is configured and a paging time window (PTW) is not included, the wireless device is in an RRC_INACTIVE state, and the target paging cycle is a shortest of: a RAN paging cycle and the extended DRX value.

6. The method of claim 1, wherein the extended DRX value is configured as 1024 radio frames, the wireless device is in an RRC_INACTIVE state, and the target paging cycle is the extended DRX value.

7. The method of claim 1, wherein the extended DRX value is configured by an upper layer.

8. An apparatus for wireless communication comprising a processor configured to:
determine a target paging cycle associated with a wireless device based on whether an extended discontinuous reception (DRX) value is configured.

9. The apparatus of claim 8, wherein the extended DRX value is not configured, and wherein the determining the target paging cycle is further based on whether a UE specific paging cycle is configured.

10. The apparatus of claim 9, wherein the UE specific paging cycle is configured, and the target paging cycle is a shortest of: a radio access network (RAN) paging cycle, a default paging cycle, and the UE specific paging cycle.

11. The apparatus of claim 9, wherein the UE specific paging cycle is not configured, and the target paging cycle is a shortest of: a RAN paging cycle and a default paging cycle.

12. The apparatus of claim 8, wherein the extended DRX value is configured and a paging time window (PTW) is not included, the apparatus is in an RRC_INACTIVE state, and the target paging cycle is a shortest of: a RAN paging cycle and an extended DRX value.

13. The apparatus of claim 8, wherein the extended DRX value is configured as 1024 radio frames, the apparatus is in an RRC_INACTIVE state, and the target paging cycle is the extended DRX value.

14. The apparatus of claim 8, wherein the extended DRX value is configured by an upper layer.

15. A computer-readable medium having code stored thereon, the code, when executed by a processor, causing the processor to implement a method comprising:
determining a target paging cycle associated with a wireless device based on whether an extended discontinuous reception (DRX) value is configured.

16. The computer-readable medium of claim 15, wherein the extended DRX value is not configured, and wherein the determining the target paging cycle is further based on whether a UE specific paging cycle is configured.

17. The computer-readable medium of claim 16, wherein the UE specific paging cycle is configured, and the target paging cycle is a shortest of: a radio access network (RAN) paging cycle, a default paging cycle, and the UE specific paging cycle.

18. The computer-readable medium of claim 16, wherein the UE specific paging cycle is not configured, and the target paging cycle is a shortest of: a RAN paging cycle and a default paging cycle.

19. The computer-readable medium of claim 15, wherein the extended DRX value is configured and a paging time window (PTW) is not included, the wireless device is in an RRC_INACTIVE state, and the target paging cycle is a shortest of: a RAN paging cycle and the extended DRX value.

20. The computer-readable medium of claim 15, wherein the extended DRX value is configured as 1024 radio frames, the wireless device is in an RRC_INACTIVE state, and the target paging cycle is the extended DRX value.
